(19) United States
(12) Patent Application Publication
(10) Pub. No.: US 2013/0216016 A1
(43) Pub. Date: Aug. 22, 2013

(54) Device for Mitigating Serious Accidents for a Nuclear Fuel Assembly, With Improved Effectiveness

(71) Applicant: Christophe Journeau, Venelles (FR)

(72) Inventor: Christophe Journeau, Venelles (FR)

(73) Assignee: Commissariat a L'energie atomique et aux energies alternatives, Paris (FR)

(21) Appl. No.: 13/818,499

(22) PCT Filed: Aug. 25, 2011
(86) PCT No.: PCT/EP11/64627

§ 371 Date: Mar. 21, 2013

(30) Foreign Application Priority Data
Aug. 25, 2010 (FR) 1056754

(51) Int. Cl. G21C 9/02

(52) U.S. Cl. CPC G21C 9/022
USPC 376/336

(57) ABSTRACT

Passive safety device (104) designed to be placed near the top of a nuclear fuel assembly (102), comprising:

a neutron-absorbing material and a material capable of forming a low melting point eutectic with the material forming the cladding of the nuclear fuel rods (8) in the assembly (102), and

fused means (28) to retain said materials in the high position in the assembly (102).

### TECHNICAL DOMAIN AND PRIOR ART

This invention relates to a passive safety device comprising a neutron-absorbing material, the passive safety device being integrated into a nuclear fuel assembly. Such an assembly is designed to be placed in the core of a nuclear reactor, particularly in the centre of a fast neutron nuclear reactor cooled by a liquid metal.

Nuclear reactors comprise safety devices designed to slow or even stop the nuclear reaction inside the reactor when an accident occurs. To achieve this, the nuclear reactor comprises control rods suspended above the core and released into the core in the case of an accident. The control rods are made from a neutron-absorbing material, usually boron carbide. The control rods are suspended for example by means of grabs or an electromagnet that release the control rods on order. This safety device is said to be active, because it requires outside action to be triggered.

Nuclear reactors comprise redundant safety devices, also called complementary shutdown systems (SAC), to compensate for unavailability of the active safety device. The redundant safety device is designed based on a different physical principle, to maximise safety.

Furthermore, as mentioned above, the safety device formed by the control rods requires outside action. It was then thought that safety devices triggered independently without requiring any external order could be used, these devices then being called passive safety devices. One type of safety device passively inserting a neutron-absorbing material into the core is disclosed in documents FR 2 230 984 and FR 2 683 667. These passive devices use a fuse that causes the neutron-absorbing material to drop when the temperature rises due to an accident situation.

Document FR 2 683 667 discloses an assembly comprising a matrix made of a fuse material in its upper part above the fuel rods, inside which elements of a neutron-absorbing material are trapped. When the temperature rises above a given threshold, the matrix melts and the elements drop on or between the rods, and slow down or interrupt the fissile reaction.

When an accident occurs in a liquid metal-cooled fast neutron reactor, local boiling of the metal coolant and melting of the metal forming the cladding around the rods and then the fuel contained inside the cladding, are observed very quickly, within approximately one second. Expansion of metal vapour causes upwards displacement of the molten metal from the cladding towards the top of the assembly, and this molten metal will then solidify in contact with cooler zones to form a plug.

The inventor has discovered that if the trigger time of the fuse mechanism of the passive safety device containing the neutron-absorbing material is too long, the metal plug will be inserted between the fissile nuclear fuel and the material designed to stop the fission reaction, making the passive safety device ineffective or at least delaying its effectiveness.

Consequently, one of the purposes of this invention is to provide means of overcoming the disadvantage discovered by the inventor and mentioned above.

### PRESENTATION OF THE INVENTION

The purpose mentioned above is achieved by a passive safety device comprising a first neutron-absorbing material and a second material capable of combining with the material forming the plug, and particularly with the metal or metal alloy forming the cladding of the metal fuel rods, to form a low melting point eutectic. Thus, when the neutron-absorbing material and the eutectic material with a eutectic with a low melting point are released, they drop onto the plug, and a eutectic is then formed at the interface between the plug and the second material. At the temperature within the assembly, this eutectic melts and the first neutron-absorbing material can then join the fission zone and interrupt the fission reaction.

Note that the eutectic is the melting point on the phase diagram at which the mix is at its minimum temperature in the liquid phase. “Low melting point eutectic” means a eutectic below the melting point of steel, in practice less than 1400° C.

In the remainder of this description, the material capable of combining with the cladding material to form an eutectic with a low melting point will be referred to as “material for eutectic”.

In the case of a sodium-cooled fast neutron reactor, the material for eutectic is chosen such that it combines with the iron in the steel from which the cladding of nuclear fuel rods is usually made, to form a low melting point eutectic.

In one particularly advantageous embodiment, a material for eutectic with a high density is chosen such that there is a mechanical mass effect applied by the material for eutectic onto the plug to accelerate the passage of the neutron-absorbing material through the plug; advantageously, the density of the material for eutectic is higher than the density of steel.

For example, in the case of sodium-cooled fast neutron reactors, uranium (preferably natural or depleted) is chosen which has a eutectic with iron at 725° C. and 1080° C. and a density of 18950 kg/m³.

In one very advantageous example, a neutron-absorbing material that also combines with steel to form a low melting point eutectic is chosen. Pure hafnium, alloyed hafnium or a hafnium-uranium alloy can be chosen, and in a hafnium-uranium alloy, the hafnium is absorbent, it has a high density and alloyed with uranium, it combines with the steel in the cladding to form a low melting point eutectic.

The subject-matter of this invention is then a passive safety device that can be placed near the top of a nuclear fuel assembly, comprising:

a neutron-absorbing material and a material capable of forming a low melting point eutectic with the material forming the cladding of the nuclear fuel rods in the assembly, and

fused means to retain said materials in the high position in the assembly.

Very advantageously, at least part of the material that can form a low melting point eutectic is a neutron-absorbing material.

Preferably, the material capable of forming a low melting point eutectic has a high density, higher than or equal to the density of the material from which the cladding is made, for example more than 7000 kg/m³ when the cladding is made of steel.

In one example embodiment, the cladding is made of steel and the material forming a low melting point eutectic is made of natural or depleted uranium.

In another example embodiment, the cladding is made of steel and the material forming a low melting point eutectic is pure or alloyed hafnium. Slightly alloyed hafnium may contain not more than 20% by mass of alloy materials. The alloy material may for example be nickel, chromium, boron or tungsten.

In another example embodiment, the cladding is made of steel and the material forming a low melting point eutectic is a natural or depleted uranium-hafnium alloy. The uranium-hafnium alloy may comprise not more than 45% atomic of natural or depleted uranium.

The passive safety device according to one embodiment comprises a tube that can be arranged along the axis of the assembly and in which the neutron-absorbing material and the material capable of combining with the material from which the cladding is made to form a low melting point eutectic are in the form of separate elements mounted on a wire that will be suspended from a top end of the assembly, said wire comprising lower fuse stop means.

In another example embodiment, the neutron-absorbing material and the material capable of combining with the material in the cladding to form a low melting point eutectic are in the form of elements dispersed in a low melting point matrix, said matrix comprising a central passage that will be coaxial with the axis of the assembly. The device may advantageously comprise an inner retaining casing surrounded by the matrix and adjacent to the central passage, said inner retaining casing comprising perforations.

Another subject-matter of this invention is a nuclear fuel assembly comprising a casing, nuclear fuel rods and a passive safety device according to this invention.

Another subject-matter of this invention is a nuclear reactor comprising several assemblies according to this invention arranged adjacent to each other. The reactor is preferably a sodium-cooled fast neutron reactor.

### BRIEF DESCRIPTION OF THE DRAWINGS

This invention will be better understood after reading the following description and with reference to the appended drawings in which:

FIG. 1 is a longitudinal sectional view of an assembly fitted with a passive safety device according to a first embodiment of this invention shown diagrammatically;

FIG. 2 is a longitudinal sectional view of an assembly fitted with a passive safety device according to a second embodiment of this invention shown diagrammatically.

### DETAILED PRESENTATION OF PARTICULAR EMBODIMENTS

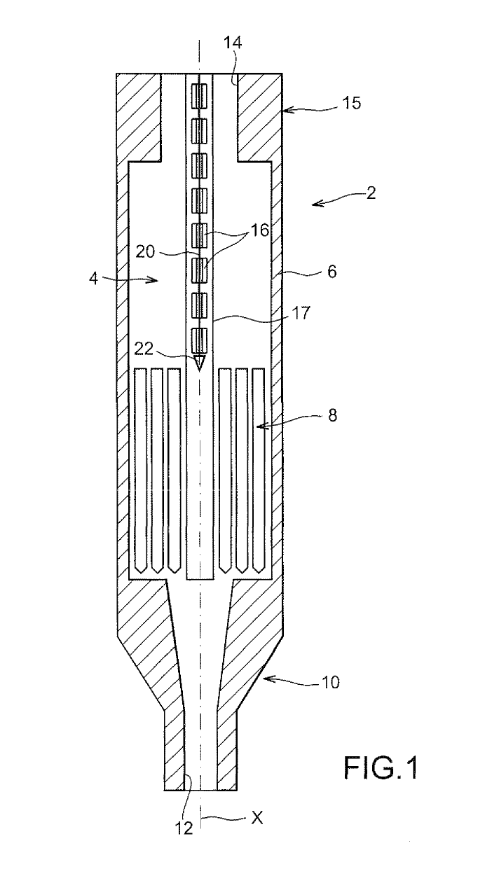

FIG. 1 very diagrammatically shows a nuclear fuel assembly 2 comprising a passive safety device 4 according to a first embodiment.

The assembly comprises a casing 6 with a longitudinal axis X usually with a hexagonal cross-section, and nuclear fuel rods 8 arranged approximately in a median part of the casing.

The assembly is usually installed in the low part 10, called the bottom of the assembly in a diagrid (not shown) supporting it and also the other assemblies and supplying the assemblies with liquid metal coolant. The assembly comprises a liquid metal inlet 12 in the lower part, and a liquid metal outlet 14 in the upper part, the liquid metal being transported by pumps. Therefore the liquid metal circulates from the bottom of the assembly towards the top and extracts heat generated by the fissile reaction from the rods.

The passive safety device 4 according to this invention is arranged in the top part 15 of the assembly. In the example shown, the passive safety device comprises a tube 17 arranged along the longitudinal axis X of the assembly in which a neutron-absorbing material, hereinafter referred to as the “absorbent material”, is placed. The absorbent material and the material for eutectic 16 are in the form of cylindrical elements mounted around a wire 20 suspended at a top end of the assembly. The wire 20 comprises lower stop means 22 to retain the cylindrical elements 16. The stop means 22 are fuses, in other words they melt under given conditions, thus releasing the cylindrical elements that can drop between the rods along the wire 20. Melting may be due to either a temperature increase or to an increase in the neutron flux. In the latter case, a small quantity of fissile material can be placed close to the fuse stop, which will cause melting due to the heat that it releases, when there is an abnormal increase in reactivity or when cooling is reduced.

In the remainder of this description, we will consider the example of sodium-cooled fast neutron reactors, however the invention is obviously applicable to all fast neutron reactors cooled by a liquid metal coolant other than sodium, and to all reactors requiring the use of passive safety devices.

In sodium-cooled fast neutron reactors, the fuel rod cladding is made of steel, i.e. a metal alloy composed primarily of iron.

According to this invention, a material will be dropped onto the molten steel plug to form a low melting point eutectic with the steel from which the cladding is made, and particularly with iron.

In a first example embodiment, the material is natural or depleted uranium in the form of a metal. It is then planned to associate uranium with an absorbent material, for example boron or gadolinium, which will fulfil the conventional function of an absorbing material in a passive safety device.

Uranium forms eutectics at 725° C. and 1080° C. with iron. Consequently, when it comes into contact with the steel in the plug formed by melting of the cladding, it combines with iron to form a eutectic with a melting point of 725° C. or 1080° C., this eutectic then partially melts under the temperature conditions of the accident, enabling the absorbent material to pass towards the fissile fuel zone.

Note that the melting temperature of pure iron is of the order of 1550° C., and that the steel in the molten cladding resolidifies in the “cold zone” for which the temperature is of the order of 1500° C. Consequently, the eutectic formed by iron and uranium easily melts in this cold zone.

The cladding can be made of austenitic steel or Oxide Dispersion Strengthened (ODS) steel. Their melting temperature is between 1400° C. and 1500° C.

Uranium also has a high density, higher than steel, and when it drops on the molten steel plug, it has a metal mass effect weakening the plug which is more sensitive to creep at the temperatures considered. The density of uranium at ambient temperature is 18950 kg/m³.

The absorbing properties of uranium are not sufficient but it does perform a fuel dilution function. Preferably, uranium depleted with the 235 fissile isotope is chosen, which enables dilution of uranium enriched with the 235 fissile isotope and plutonium forming the fuel, which reduces risks of criticality.

In another example embodiment, the absorbent material is an alloy of natural or depleted uranium and hafnium.

This alloy acts on the plug in a manner similar to uranium; this alloy has a low melting point eutectic with steel, in a similar manner to uranium. This alloy also has high density because the density of hafnium is 13300 kg/m³.

Furthermore, this alloy has an advantage over uranium alone in that it has neutron-absorbing properties directly because hafnium has absorbing properties.

This alloy also reduces risks of criticality due to segregation between the molten mixed uranium and plutonium oxide phase and the molten metallic steel phase of the cladding, which are not very miscible or are immiscible. This low miscibility reduces the dilution phenomenon causing the reduction of criticality risks.

This alloy, and particularly the hafnium, acts on the molten mixed uranium and plutonium oxide fuel due to its oxydo-reduction properties. Hafnium has reducing properties relative to uranium; hafnium is more reducing than uranium and plutonium. Consequently, when hafnium comes into contact with uranium oxide, part of the uranium oxide is reduced into uranium and hafnium oxidises into hafnia.

The metallic uranium thus formed mixes with the metallic phase composed of hafnium, uranium and mainly molten steel with which it previously had low miscibility. Hafnia mixes with the remaining enriched uranium and plutonium oxide.

Firstly, the liquid metallic phase and the liquid oxide phase are in less critical neutron configurations: dilution of metallic uranium (and/or plutonium) by steel in the metallic phase, and attenuation by hafnia in the oxide phase.

Secondly, the reduction of uranium oxide enables transfer of part of the fuel to the metallic phase, where it is in a small proportion. The fuel phase is also “diluted” due to the presence of hafnia and the removal of some of the uranium oxide.

For example, the alloy may contain up to 45% atomic of uranium.

In another example embodiment, pure or slightly alloyed hafnium is used, for example containing for example 5 or 10% by mass of alloy materials and not more than 20% by mass.

Hafnium has a high density of 13300 kg/m³, which is more than steel, a low melting point eutectic even if it is more than the melting point of uranium and the uranium-hafnium alloy. Very advantageously, it has a greater absorbing capacity than the uranium-hafnium alloy.

For example, hafnium and tungsten, hafnium and chromium, hafnium and boron or hafnium and nickel alloys can be used. The hafnium and nickel alloy has the advantage that it forms a very low melting point eutectic with steel, and particularly with iron.

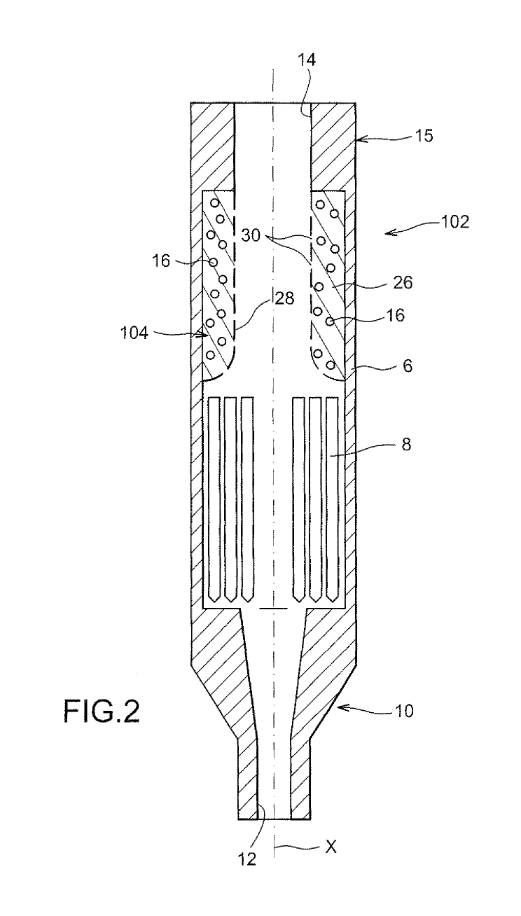

FIG. 2 shows another example embodiment; an assembly 102 equipped with a passive safety device 104 according to this invention, arranged like the device 4 in FIG. 1 near the top of the assembly.

The device 104 has an annular shape in which coolant can pass through the central passage coaxial with the axis of the assembly 102.

The device comprises one or several materials 16 identical to those described above, such as uranium associated with an absorbent material, a depleted uranium-hafnium alloy, pure hafnium or slightly alloyed hafnium, and fuse means retaining said materials in the high position under normal operating conditions and allowing them to drop towards the cladding under abnormal operating conditions, i.e. when the temperature in the core and therefore in the coolant increases.

Advantageously, these fuse retaining means 24 are formed by a matrix 26 in which the material(s) 16 are embedded in the form of discrete elements.

In the example shown, the matrix 26 is surrounded by an inner retaining casing 28 with perforations 30 to allow elements 16 to pass through. The matrix is then housed between the outer casing 6 of the assembly and the inner retaining casing 28.

The matrix 26 is made of a material which does conduct heat, but for which the melting point is very much less than the boiling point of the coolant at the pressure considered. For example, the matrix may be aluminium, aluminium alloy, alumina fibre reinforced aluminium or silicon carbide reinforced aluminium. For example, the inner casing may be made of stainless steel.

The passive safety device in FIG. 2 functions as follows; when the temperature of the coolant reaches a predetermined value, the matrix melts, releasing elements 16 which pass through the perforations 30 and drop onto the molten steel plug. The operation that follows this drop is identical to the operation described previously, and will not be repeated herein.

Advantageously, corium collectors (not shown) are provided below the assemblies to recover corium formed during melting of the assembly; these collectors consist either of trays arranged below each assembly, or one or several trays arranged in the bottom of the vessel.

The trays preferably contain an absorbent material capable of acting on the molten fuel contained in the corium. Particularly advantageously, pure or slightly alloyed hafnium could be placed in these collectors, the hafnium causing reduction of part of the fuel as described above, and its transfer to the metal phase, thus reducing risks of criticality.

For example, the collector comprises a cover protecting the hafnium under normal operating conditions, this cover then breaking when the molten corium flows. For example, the hafnium may be in the form of bars in the collector.

Therefore, this invention can significantly improve the effectiveness of passive safety devices creating contact between absorbent materials and the nuclear fuel, despite the presence of a metal plug between the passive safety device and the rods.

Obviously, the use of pure uranium elements and pure hafnium elements could be envisaged instead of an alloy of the two.

1-15. (canceled)

16. Passive safety device designed to be placed near the top of a nuclear fuel assembly, comprising:
a neutron-absorbing material and a material capable of forming an eutectic with a low melting point with the iron of the steel of the cladding of the nuclear fuel rods in the assembly, and
fused means to retain said materials in the high position in the assembly,
the material capable of forming an eutectic with a low melting point having a density higher than or equal to the density of the steel from which the cladding is made.

17. Passive safety device according to claim 16, in which at least part of the material capable of forming a low melting point eutectic is a neutron-absorbing material.

18. Passive safety device according to claim 16, in which the material capable of forming a low melting point eutectic has a density higher than 7000 kg/m³.

19. Passive safety device according to claim 16, in which the cladding is made of steel and the material forming a low melting point eutectic is made of natural or depleted uranium.

20. Passive safety device according to claim 18, in which the cladding is made of steel and the material forming a low melting point eutectic is pure or alloyed hafnium.

21. Passive safety device according to claim 20, in which the slightly alloyed hafnium contains not more than 20% by mass of alloy materials.

22. Passive safety device according to claim 21, in which the alloy material is nickel, chromium, boron or tungsten.

23. Passive safety device according to claim 18, in which the cladding is made of steel and the material forming a low melting point eutectic is a natural or depleted uranium-hafnium alloy.

24. Passive safety device according to claim 23, in which the uranium-hafnium alloy comprises not more than 45% atomic of natural or depleted uranium.

25. Passive safety device according to claim 16, comprising a tube that can be arranged along the axis of the assembly and in which the neutron-absorbing material and the material capable of forming an eutectic with a low melting point with the iron of the steel of the cladding, are in the form of separate elements mounted on a wire that will be suspended from a top end of the assembly, said wire comprising lower fuse stop means.

26. Passive safety device according to claim 16, in which the neutron-absorbing material and the material capable of forming an eutectic with a low melting point with the iron of the steel of the cladding, are in the form of elements dispersed in a low melting point matrix (26), said matrix comprising a central passage that will be coaxial with the axis of the assembly.

27. Passive safety device according to claim 26, comprising an inner retaining casing surrounded by the matrix and adjacent to the central passage, said inner retaining casing comprising perforations.

28. Nuclear fuel assembly comprising a casing, nuclear fuel rods and a passive safety device according to claim 16.

29. Nuclear reactor comprising several assemblies according to claim 28 arranged adjacent to each other.

30. Nuclear reactor according to claim 29, the reactor being a sodium-cooled fast neutron reactor.
